(19) United States
(12) Patent Application Publication
(10) Pub. No.: US 2008/0051189 A1
(43) Pub. Date: Feb. 28, 2008

(54) Gaming machine which determines award based on combination of symbols at which moving character stops and playing method for gaming machine

(75) Inventor: Katsuhiro Kido, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/892,167

(22) Filed: Aug. 20, 2007

(30) Foreign Application Priority Data
Aug. 21, 2006 (JP) 2006-224425

(51) Int. Cl. A63F 5/04; A63F 13/00

(52) U.S. Cl. 463/20

(57) ABSTRACT

A gaming machine includes a display and a game controller. The display displays thereon a symbol display area in which one of kinds of symbols is arranged, and a symbol display frame made up of symbol display areas. The game controller performs: moving a character that moves within the symbol display frame, in a state where symbols are displayed in the respective symbol display areas included in the symbol display frame; determining one symbol display area in which the character will be stopped, from the symbol display areas included in the symbol display frame; and determining an award given to a player based on a combination of symbols corresponding to symbol display areas in each of which the character is stopped.

### CROSS REFERENCE TO RELATED APPLICATION

This application is based upon and claims the benefit of priority from the prior Japanese Patent Application No. 2006-224425, filed on Aug. 21, 2006, the entire contents of which are incorporated herein by reference.

### BACKGROUND OF THE INVENTION

1. Field of the Invention

The present invention relates to a gaming machine that gives an award based on a combination of arranged symbols and also relates to a playing method for the gaming machine. More particularly, the present invention relates to a gaming machine that randomly displays a moving character over arranged symbols and determines an award given to a player based on a combination of symbols at which the moving character stops, and also relates to a playing method for the gaming machine.

2. Description of Related Art

Conventionally, in a general gaming machine, symbol display areas are arranged in a matrix. In each of the symbol display areas, one symbol included in a column of several symbols is placed. In such a general gaming machine, an award given to a player is determined based on a combination of symbols placed in, among the symbol display areas arranged in the matrix, symbol display areas located on a certain activated pay line of linear shape. However, determining an award based on a combination of symbols placed on a linear activated pay line is too common a manner and therefore a player can easily guess an award. Thus, the manner adopting such a linear activated pay line is not effective in terms of improving amusement of a game.

Accordingly, a gaming machine that adds variation to the activated pay line and a gaming machine that does not adopt an idea of the activated pay line have now been developed. For example, gaming machines disclosed in U.S. Pat. No. 6,093,102 and in U.S. Pat. No. 6,960,133 are known as a gaming machine that determines an award not only by a combination of symbols placed on a linear activated pay line. In the gaming machines disclosed in the above-mentioned documents, when determining an award, variation is added to the activated pay line or no idea of the activated pay line is adopted. However, presenting a game result to a player by means of symbol display areas arranged in a matrix is eventually equal to determining an award based on a combination of symbols placed on a linear activated pay line. Accordingly, there is no effectiveness in terms of improving amusement of a game.

### SUMMARY OF THE INVENTION

An object of the present invention is to provide a gaming machine that notifies a game result in a manner different from conventional manners and visually improves pleasure of a player, and also to provide a playing method for the gaming machine.

According to a first aspect of the present invention, there is provided a gaming machine comprising a display and a game controller. The display displays thereon a symbol display area in which one of a plurality of kinds of symbols is arranged, and a symbol display frame made up of a plurality of symbol display areas. The game controller performs: moving a character that moves within the symbol display frame, in a state where symbols are displayed in the respective symbol display areas included in the symbol display frame; determining one symbol display area in which the character will be stopped, from the plurality of symbol display areas included in the symbol display frame; and determining an award given to a player based on a combination of symbols corresponding to symbol display areas in each of which the character is stopped.

According to a second aspect of the present invention, there is provided a playing method for a gaming machine. In the playing method for a gaming machine, when a game controller arranges symbols in a symbol display frame that is displayed on a display and made up of a plurality of symbol display areas in each of which one of a plurality of symbols is arranged, the game controller performs: moving a character that moves within the symbol display frame, in a state where symbols are displayed in the respective symbol display areas included in the symbol display frame; determining one symbol display area in which the character will be stopped, from the plurality of symbol display areas included in the symbol display frame; and determining an award given to a player based on a combination of symbols corresponding to symbol display areas in each of which the character is stopped.

In the first and second aspects, a symbol display frame made up of a plurality of symbol display areas is displayed on a display, and symbols are arranged in the respective symbol display areas. A character moves within the symbol display frame, and then stops in a symbol display area determined for the character. An award given to a player is determined based on a combination of symbols corresponding to the symbol display areas in each of which the character is stopped. As a result, in the gaming machine and the playing method for the gaming machine according to the present invention, an award is determined depending not on a linear activated pay line but on a combination of symbols in which characters are stopped. Thus, a player can enjoy longer-term expectation for an award, because he/she cannot know which combination of symbols is accomplished until a movement of the character ends. In addition, displaying a movement of the character within the symbol display frame is performed at random. This provides a wider variety of display modes on the display. Accordingly, in the symbol display frame, there are a variety of display modes presented until a player is notified of a game result. Thus, there can be provided a gaming machine and a playing method for a gaming machine that visually present a great pleasure.

### BRIEF DESCRIPTION OF THE DRAWINGS

Other and further objects, features and advantages of the invention will appear more fully from the following description taken in connection with the accompanying drawings in which:

FIG. 1 is an explanatory view showing a display mode of a lower display while butterfly character images are moving;

FIG. 2 is an explanatory view showing a display mode of the lower display before the moving butterfly character images are displayed;

FIG. 3 is an explanatory view showing a display mode of the lower display after a display of the moving butterfly character images ends;

FIG. 4 is a front view showing a symbol display section according to an embodiment of the present invention;

FIG. 5 is a payout table showing awards that are paid out to a player based on combinations of symbols;

FIG. 6 is a perspective view showing an appearance of a gaming machine according to a first embodiment;

FIG. 7 is a block diagram showing a control system of the gaming machine according to the first embodiment;

FIG. 8 is a flowchart showing a main control processing program;

FIG. 9 is a flowchart showing a main game processing program;

FIG. 10 is an explanatory view concerning a character number determination table;

FIG. 11 is an explanatory view concerning a stopping area determination table;

FIG. 12 is a flowchart showing a character display processing program;

FIG. 13 is an explanatory view concerning a movement pattern determination table;

FIG. 14 is explanatory views showing specific examples of a movement pattern;

FIG. 15 is an explanatory view schematically showing a movement pattern (C);

FIG. 16 is a perspective view showing an appearance of a gaming machine according to a second embodiment;

FIG. 17 is a block diagram showing a control system of the gaming machine according to a second embodiment; and

FIG. 18 is an explanatory view showing a column of symbols shown on peripheral surfaces of mechanical reels according to the second embodiment.

### DESCRIPTION OF THE PREFERRED EMBODIMENTS

In the following, some preferred embodiments of the present invention will be described with reference to the accompanying drawings.

### First Embodiment

A first embodiment of the present invention will be described in detail with reference to the accompanying drawings. In the first embodiment, the present invention is applied to a so-called video gaming machine. Here, a video gaming machine is a gaming machine that has an image display device such as a liquid crystal display and presents a game by displaying various symbol images on the image display device.

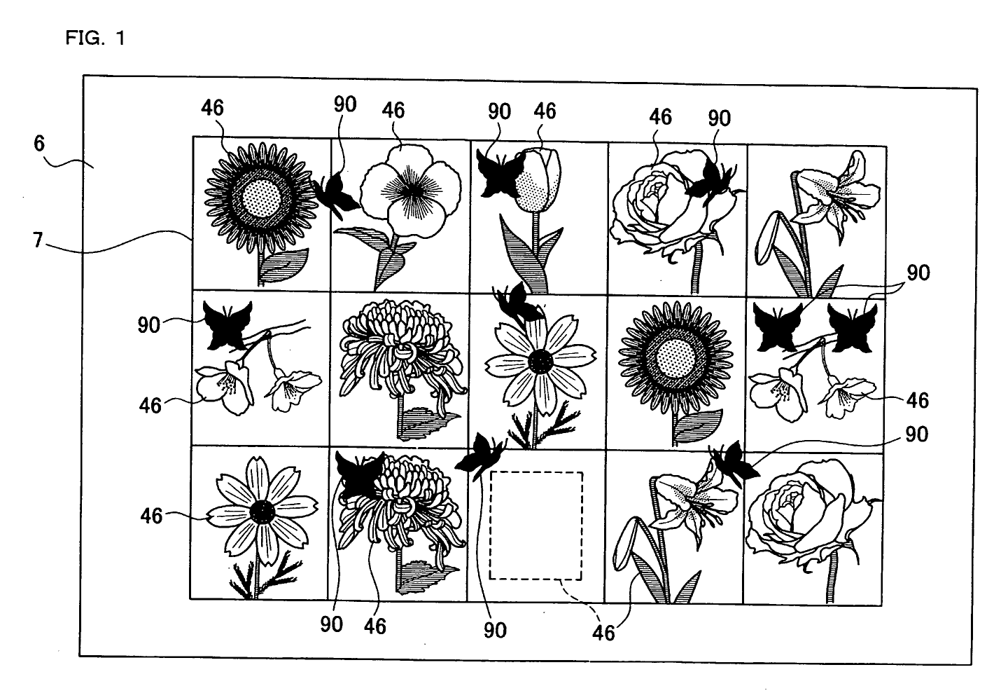

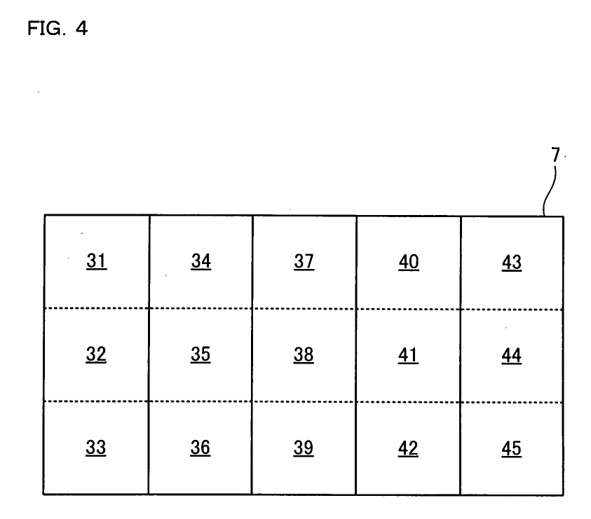

First, a game played in a gaming machine 1 according to the first embodiment will be generally described with reference to FIGS. 1 to 3. In the gaming machine 1 according to the first embodiment, when executing a game, a symbol display section 7 made up of fifteen symbol display areas 31 to 45 is displayed on a lower display 6 (see FIG. 4).

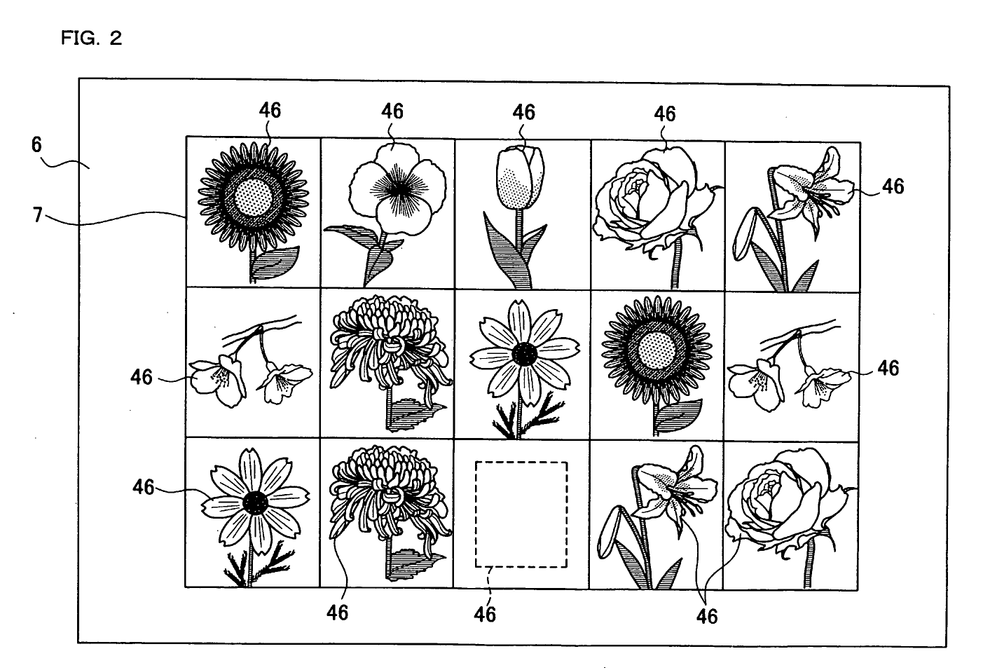

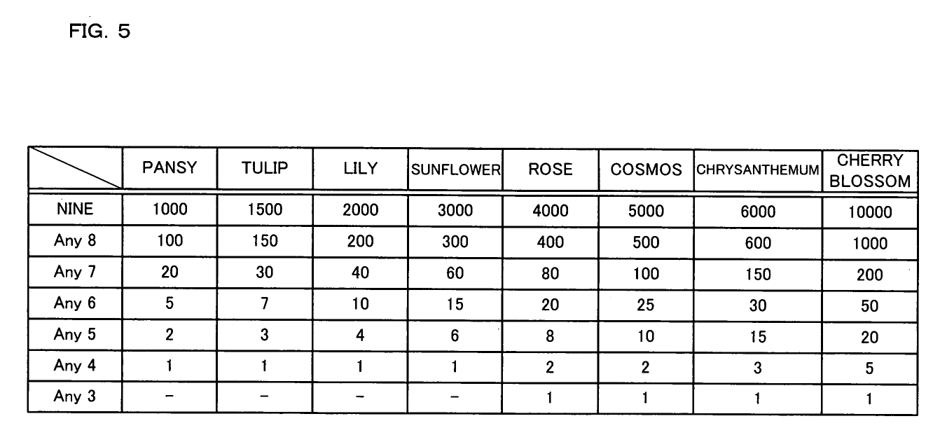

In the symbol display section 7 displayed on the lower display 6, one of nine kinds of symbols 46 is placed in each of the symbol display areas 31 to 45 (see FIG. 2). The nine kinds of symbols 46 are a “cherry blossom” symbol, a “chrysanthemum” symbol, a “cosmos” symbol, a “rose” symbol, a “sunflower” symbol, a “lily” symbol, a “tulip” symbol, and a “pansy” symbol shown in FIG. 5, plus a “blank” symbol. Here, symbols 46 placed in the respective symbol display areas 31 to 45 are always of the same kinds. For example, in an example shown in FIG. 2, a “cosmos” symbol 46 is always placed in the symbol display area 38. That is, in the gaming machine 1, the symbol display section 7 is displayed on the lower display 6 with symbols 46 being always in the same arrangement pattern shown in FIG. 2.

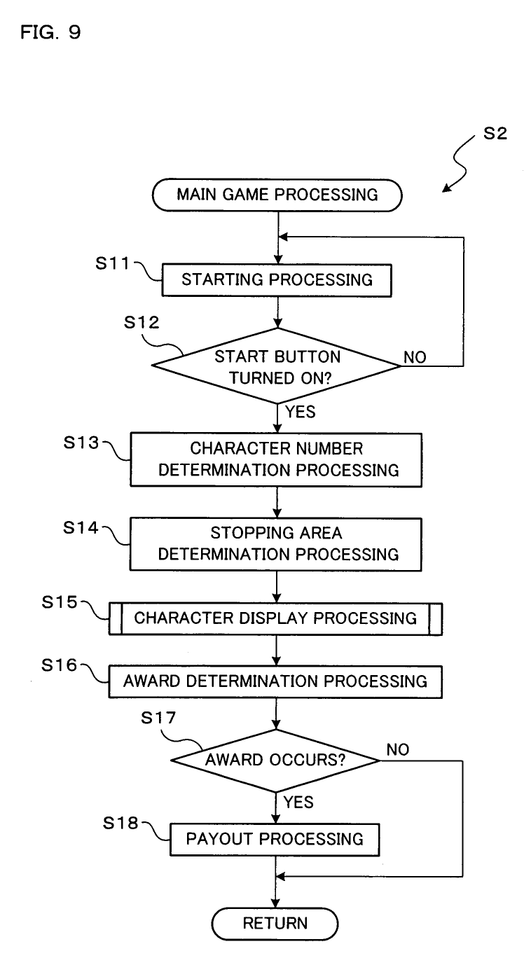

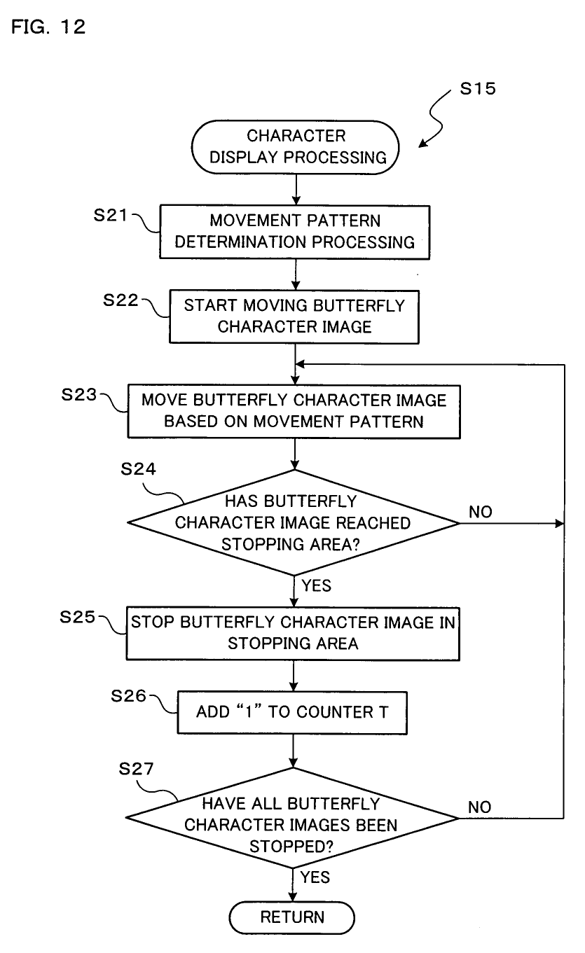

In the gaming machine 1, the symbol display section 7, in which symbols 46 are arranged in the pattern shown in FIG. 2, is displayed on the lower display 6. Then, butterfly character images 90, which correspond to a character number determined in a later-described character number determination processing S13 (see FIG. 9), are displayed on the lower display 6. The butterfly character images 90 move within the symbol display section 7 in accordance with a movement pattern which is randomly determined by a later-described character display processing S15 (see FIGS. 9 and 12). Thus, a movement is made in accordance with the movement pattern. Then, when a butterfly character image 90 reaches a symbol display area determined for this butterfly character image 90, the butterfly character image 90 stops in the symbol display area (see FIG. 1). It should be noted that, in this embodiment, a symbol display area in which a butterfly character image 90 stops is called a “stopping area”. In the gaming machine 1 of this embodiment, a stopping area for one butterfly character image 90 may be one symbol display area, and stopping areas for several butterfly character images 90 may be the same symbol display area. For example, it is possible that two butterfly character images 90 stop in one symbol display area, as in the symbol display area 44 shown in FIG. 1.

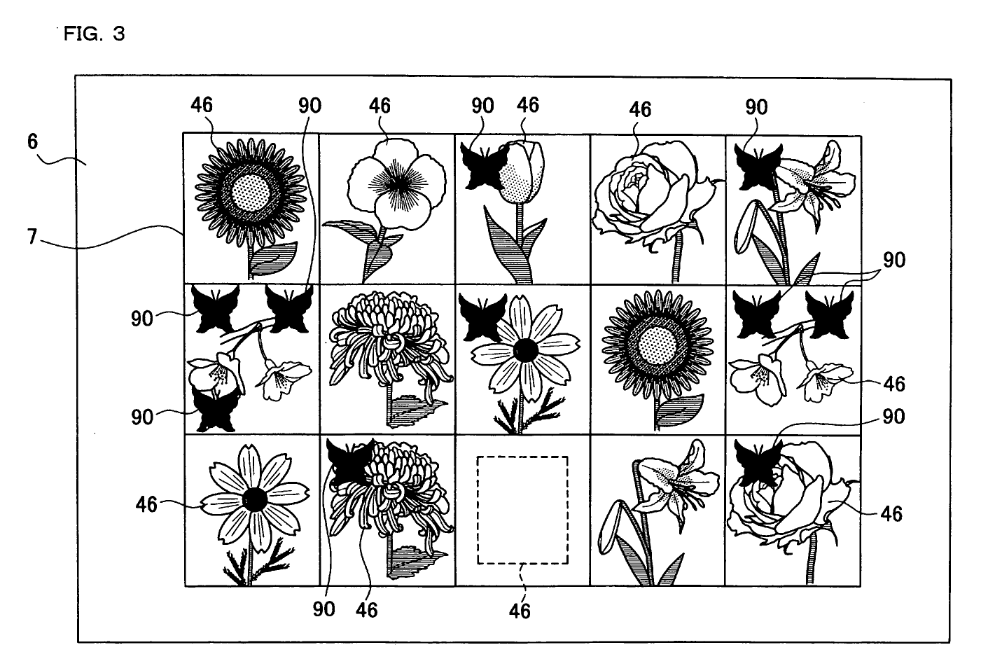

Then, when all of the butterfly character images 90 moving in the symbol display section 7 stop in the respective stopping areas (see FIG. 3), the gaming machine 1 determines an award to be given to a player based on a combination of symbols 46 placed in the stopping areas. In the gaming machine 1 of this embodiment, an award differs depending on the number of the same kind of symbols 46 among symbols 46 that are placed in the stopping areas for the butterfly character images 90 (see FIG. 5). That is, in the gaming machine 1 of this embodiment, how symbols 46 are arranged in the symbol display section 7 has no relation to winning an award, which will be understood also from the fact that an arrangement pattern of symbols 46 are always fixed. A win is made when an accomplished combination of symbols 46, which are placed in symbol display areas in which the butterfly character images 90 stop, includes not less than a predetermined number of symbols of the same kind. Then, an award corresponding to the kind and the number of the symbols is paid out (see FIG. 5).

Here, taking a case shown in FIG. 3 as an example, a specific description will be given to determination of an award. In the case shown in FIG. 3, symbols 46 placed in symbol display areas in which butterfly character images 90 stop, that is, symbols 46 placed in stopping areas are a total of ten symbols 46, namely, five “cherry blossom” symbols, one “chrysanthemum” symbol, one “cosmos” symbol, one “rose” symbol, one “lily” symbol, and one “tulip” symbol. In the case shown in FIG. 3, symbols 46 involved in determination of an award include a total of five “cherry blossom” symbols 46. Thus, an “Any 5” winning combination of “cherry blossom” is made. Therefore, in the case shown in FIG. 3, a credit of “20” is awarded to a player.

It is possible that several winning combinations are made upon determination of an award. When several winning combinations are made, all awards corresponding to the winning combinations made are given to a player. For example, in a case where not only an “Any 5” combination of “cherry blossom” but also an “Any 4” combination of “chrysanthemum” is made, a credit of “3” is added to a credit of “20” and accordingly a credit of “23” is awarded to a player.

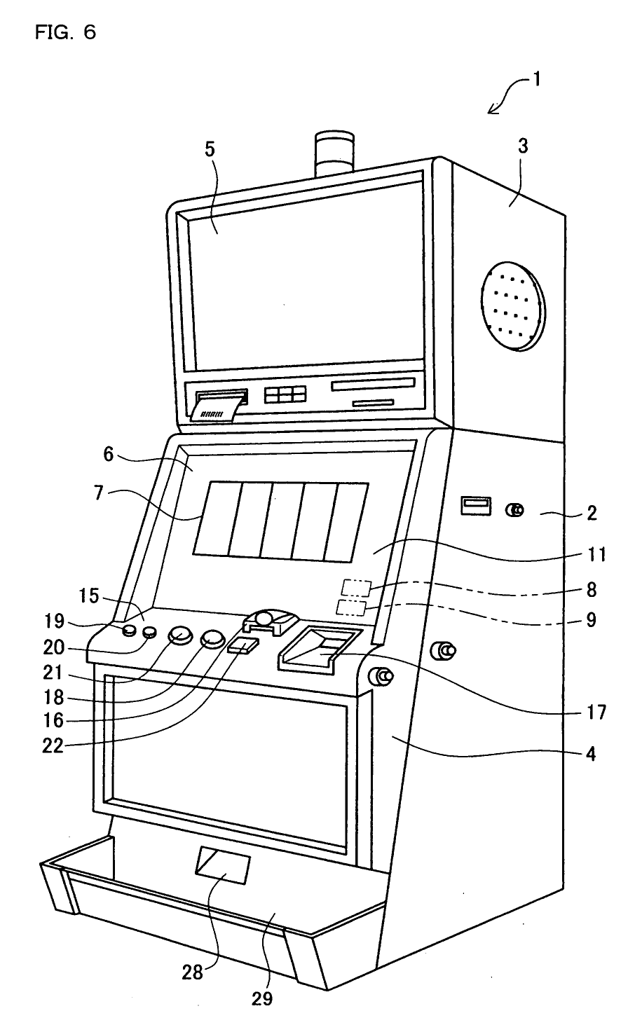

Next, a general construction of the gaming machine 1 according to the first embodiment will be described with reference to the accompanying drawings. FIG. 6 is a perspective view showing an appearance of the gaming machine 1 according to the first embodiment.

The gaming machine 1 according to the first embodiment includes a cabinet 2, a top box 3 placed on an upper side of the cabinet 2, and a main door 4 provided on a front face of the cabinet 2. An upper display 5 is provided on a front face of the top box 3. Here, the upper display 5 is made up of a known liquid crystal display. A playing manner, a payout table, and the like are displayed on the upper display 5.

On the other hand, a lower display 6 is provided on a front face of the main door 4. Here, the lower display 6 is made up of a known liquid crystal display. The lower display 6 has a symbol display section 7. The symbol display section 7 is made up of symbol display areas 31 to 45 that are arranged in five columns and three rows. That is, there are fifteen symbol display areas in the symbol display section 7, as shown in FIG. 4. In this embodiment, as described above, symbols 46 placed in the respective symbol display areas are always of the same kinds. Therefore, in a case where one game ends and then a next game starts, a kind of symbol 46 displayed in a certain symbol display area does not differ.

A touch panel 11 is provided on a front face of the lower display 6. A player is able to input various commands by operating the touch panel 11. In addition, the lower display 6 has a credit value indicator 8 and a payout number indicator 9. In the credit value indicator 8, a credit value currently held by a player is indicated. In the payout number indicator 9, an amount of an award which will be given on condition that a predetermined winning combination of symbols is stopped in the symbol display section 7 is indicated as a payout number.

A control panel 15, a coin reception slot 16, and a bill insertion slot 17 are provided below the lower display 6. The control panel 15 has buttons through which a player inputs command for making progress on a game. The coin reception slot 16 receives a coin, which is a game medium, into the cabinet 2. A start button 18, a change button 19, a CASHOUT button 20, a 1-BET button 21, and a MAX-BET button 22 are provided on the control panel 15. The start button 18 is an operation unit used for inputting a command to start a game in the gaming machine 1. The change button 19 is an operation unit used in asking a staff of a game arcade for an exchange. The CASHOUT button 20 is an operation unit used for inputting a command to pay out a number of coins, which is equivalent to a credit value held by a player, through a coin payout opening 28 into a coin tray 29, or a command to pay out a number of coins, which is equivalent to a credit value held by a player, in the form of a barcoded ticket. Here, in the first embodiment, one credit is equivalent to one coin. The 1-BET button 21 is an operation unit used for receiving a command to bet on a game one credit among all credits held by a player. The MAX-BET button 22 is an operation unit used for receiving a command to bet on a game a maximum credit value bettable on one game, among all credits held by a player. In the first embodiment, the maximum credit value bettable on one game is 50 credits. It may be possible to additionally provide various BET buttons such as a 3-BET button.

In the gaming machine 1 according to the first embodiment, a coin, a bill, or valuable electronic information (credit) equivalent to them are used as a game medium. However, a game medium applicable to the present invention is not limited thereto. For example, a medal, a token, electronic money, a ticket, and the like may be used as a game medium.

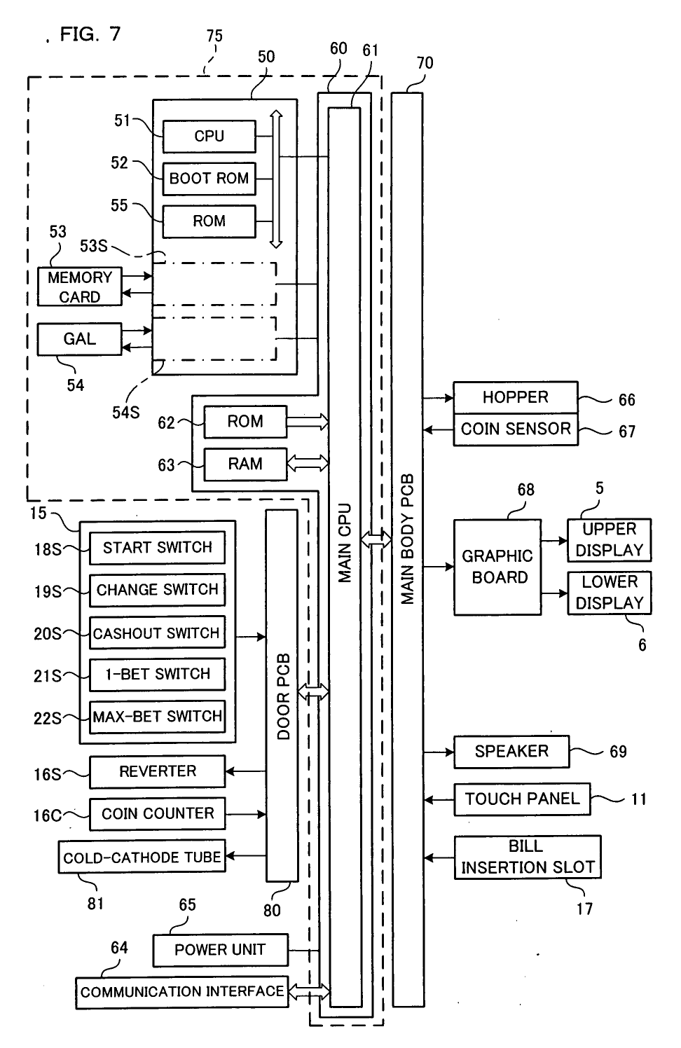

Next, a configuration of a control system of the gaming machine 1 according to the first embodiment will be described with reference to FIG. 7. FIG. 7 is a block diagram schematically showing a control system of the gaming machine 1 according to the first embodiment.

As shown in FIG. 7, a control system of the gaming machine 1 is basically made up of a mother board 60 and a gaming board 50. That is, the mother board 60 and the gaming board 50 constitute a game controller 75 that performs controllings for a game in the gaming machine 1.

The gaming board 50 will be described first. The gaming board 50 includes a CPU 51, a ROM 55, a boot ROM 52, a card slot 53S, and an IC socket 54S. The CPU 51, the ROM 55, and the boot ROM 52 are connected to each other via an internal bus. The card slot 53S is for a memory card 53. The IC socket 54S is for a GAL (General Array Logic) 54.

The memory card 53 is a memory medium formed of a non-volatile memory. A game program and a game system program (hereinafter referred to as a game program and the like) are stored in the memory card 53. The game program recorded on the memory card 53 includes a lottery program. The lottery program is a program for determining stopping areas for respective butterfly characters 90, and the like.

Next, the mother board 60 will be described. The mother board 60 is formed using a general-purpose mother board on the market, that is, a printed wiring board mounted with basic components of a personal computer. The mother board 60 has a main CPU 61, a ROM 62, a RAM 63, and a communication interface 64.

The ROM 62 is a memory device such as a flash memory. Permanent data including for example a program such as a BIOS, which is executed by the main CPU 61, are stored in the ROM 62. When the main CPU 61 executes the BIOS, predetermined peripheral units are subjected to an initialization process, and the game program and the like stored in the memory card 53 start to be captured via the gaming board 50.

Data and programs that are used when the main CPU 61 operates are stored in the RAM 63. In addition, the RAM 63 can store therein various programs such as an authentication program, the game program and the like which are read out through the gaming board 50, and various information such as a credit value currently held by a player.

The communication interface 64 is a communication device that communicates through a communication line with a server and the like placed in a game arcade.

A main body PCB 70 and a door PCB 80 which will be described later are respectively connected to the mother board 60 via USBs. The power unit 65 is also connected to the mother board 60. When power is supplied from the power unit 65 to the mother board 60, the main CPU 61 of the mother board 60 is started, and further power is supplied through the PCI bus to the gaming board 50 so that the CPU 51 is started.

A hopper 66, a coin sensor 67, a graphic board 68, a speaker 69, a touch panel 11, a bill insertion slot 17, and the like are connected to the main body PCB 70.

The graphic board 68 controls image display on the upper display 5 and the lower display 6, based on a control signal from the main CPU 61. For example, during a game, the graphic board 68 performs a general display controlling such as displaying symbols 46 in the symbol display section 7 of the lower display 6, moving and stopping a butterfly character image 90, and the like. The graphic board 68 has a frame memory with two planes for displaying the symbol display section 7 on the lower display 6. Stored on one plane (hereinafter referred to as a first plane) of the frame memory are image data including fifteen symbols 46 associated with the symbol display areas 31 to 45 which constitute the symbol display section 7. Stored on the other plane (hereinafter referred to as a second plane) of the frame memory are image data including a moving butterfly character image 90. In the graphic board 68, image data stored in the first and second planes of the frame memory are composed and written into a VRAM. In composing the image data stored in the first and second planes of the frame memory, the image data stored in the second plane take priority. Displaying on the lower display 6 during execution of a game is based on composition image data thus written into the VRAM.

The control panel 15, a reverter 16S, a coin counter 16C, and a cold-cathode tube 81 are connected to the door PCB 80. The control panel 15 includes a start switch 18S corresponding to the start button 18, a change switch 19S corresponding to the change button 19, a CASHOUT switch 20S corresponding to the CASHOUT button 20, a 1-BET switch 21S corresponding to the 1-BET button 21, and a MAX-BET switch 22S corresponding to the MAX-BET button 22. When a button corresponding to each switch is operated by a player, the switch outputs an input signal to the main CPU 61.

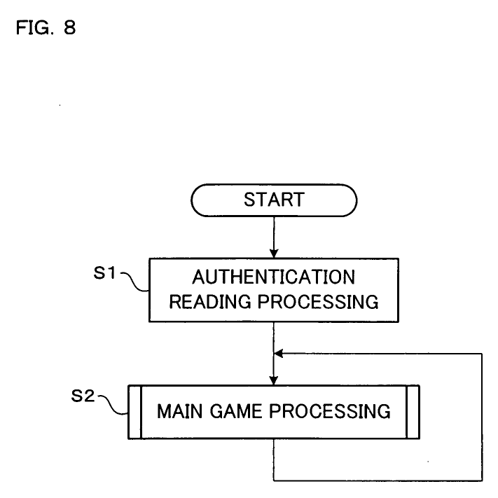

Next, a main control processing program executed in the gaming machine 1 according to the first embodiment will be described in detail with reference to the accompanying drawings. FIG. 8 is a flowchart showing a main control processing program. Here, it is presupposed that, in the gaming machine 1, the memory card 53 has already been inserted into the card slot 53S of the gaming board 50 and in addition the GAL 54 has already been mounted to the IC socket 54S of the gaming board 50.

First, when a power switch of the power unit 65 is turned on, the power unit 65 is powered up. Thus, the mother board 60 and the gaming board 50 are respectively booted up, and an authentication reading processing S1 is executed. In the authentication reading processing, the mother board 60 and the gaming board 50 execute different processings concurrently. To be more specific, in the gaming board 50, the CPU 51 reads out a preliminary authentication program that is stored in a boot ROM 52. In accordance with the preliminary authentication program thus read out, the CPU 51 performs a preliminary authentication for checking and proving that an authentication program is not falsified, before the mother board 60 downloads the authentication program. In the mother board 60, on the other hand, the main CPU 61 executes the BIOS that is stored in the ROM 62, and expands in the RAM 63 compressed data included in the BIOS. Then, the main CPU 61 executes the BIOS thus expanded in the RAM 63. The main CPU 61 also checks and initializes various peripheral units.

Then, the main CPU 61 reads out the authentication program stored in the ROM 55, and performs an authentication for checking and proving that a game program and the like stored in the memory card 53 that is inserted into the card slot 53S are not falsified. When this authentication processing is completed normally, the main CPU 61 writes the game program and the like thus authenticated, into the RAM 63. Subsequently, the main CPU 61 executes a download processing for reading payout rate setting data out of the GAL 54 through the gaming board 50, and the main CPU 61 writes the payout rate setting data thus read out into the RAM 63. After executing the above-described processing, the main CPU 61 completes the authentication reading processing.

Then, in S2, the main CPU 61 sequentially reads out of the RAM 63 the game program and the like that have been authenticated in the authentication reading processing S1, and executes them. The main CPU 61 executes a main game processing. By executing the main game processing, a game is played in the gaming machine 1 according to the first embodiment. The main game processing is executed repeatedly as long as the gaming machine 1 is supplied with power.

Next, the main game processing S2 will be described with reference to the drawings. FIG. 9 is a flowchart showing a main game processing program according to the first embodiment. Here, programs shown by the flowchart in FIG. 9 are stored in the memory card 53, expanded in the RAM 63 of the gaming machine 1, and executed by the main CPU 61.

As shown in FIG. 9, first, after executing a predetermined initialization processing, the main CPU 61 executes a starting processing S11. In the initialization processing, data clearing about an item in a predetermined data field (e.g., a payout number counter) and the like are performed. In the starting processing S11, a player performs a bet operation by inserting a coin or using the 1-BET button 21 or the MAX-BET button 22, so that a coin insertion, a bet value, and the like are set.

Then, in S12, the main CPU 61 determines whether the start button 18 has been inputted or not. Here, whether the start button 18 has been inputted or not is determined based on whether an input signal has been received from the start switch 18S or not. When the start button 18 has not been inputted (S12: NO), the main CPU 61 returns the processing to the starting processing S11 again. At this time, operations such as changing a bet value are permitted. When the start button 18 has been inputted (S12: YES), the main CPU 61 subtracts from a currently-held credit value a bet value that has been set based on an operation of the 1-BET button 21 or the MAX-BET button 22. Then, the main CPU 61 stores the bet value into the RAM 63 as bet data.

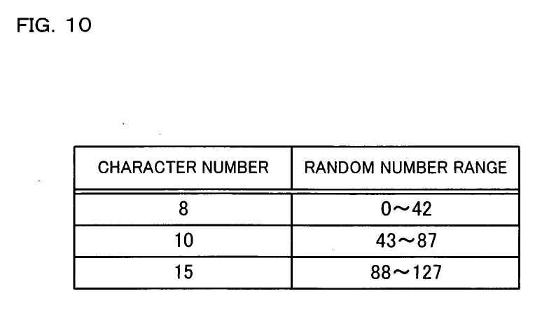

Then, in S13, the main CPU 61 executes a character number determination processing. This symbol determination processing S13 is a processing for determining the number of butterfly character images 90 to be displayed in the symbol display section 7. In other words, the character number determination processing S13 is a processing for determining the number of symbols 46 to be involved in determination of an award. In the character number determination processing S13, the main CPU 61 executes a random number generating program that is included in the lottery program stored in the RAM 63, to thereby sample a random number from a predetermined random number range. Then, based on the random number thus sampled and a character number determination table (see FIG. 10), the main CPU 61 determines the number of butterfly character images 90 to be displayed in the symbol display section 7 in the current game.

Here, the character number determination table used in the character number determination processing S13 will be described in detail with reference to FIG. 10. In the gaming machine 1 of this embodiment, there are three patterns in which the numbers of butterfly character images 90 displayed in the symbol display section 7 are “8”, “10”, and “15”. Accordingly, in the character number determination table, each of the character numbers “8”, “10”, and “15” is associated with a predetermined random number range, as shown in FIG. 10. That is, the number of characters for the current game is determined depending on which character number is associated with the random number range to which the random number sampled by the random number generating program belongs. After storing the character number thus determined into the RAM 63, the main CPU 61 advances the processing to S14.

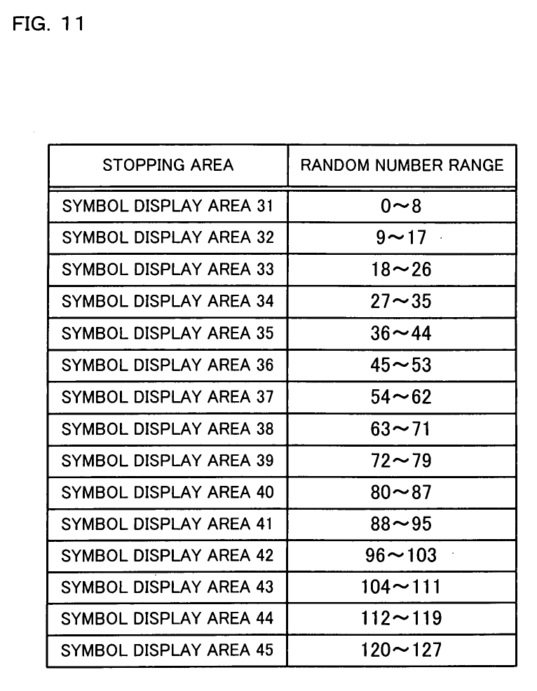

In S14, the main CPU 61 executes a stopping area determination processing. The stopping area determination processing S14 is a processing for determining a stopping area from the fifteen symbol display areas 31 to 45 included in the symbol display section 7. Here, the stopping area means a symbol display area in which a butterfly character image 90 stops. More specifically, in the stopping area determination processing S14, the main CPU 61 executes the random number generating program, to thereby sample a random number from a predetermined random number range. Then, the main CPU 61 refers to a stopping area determination table in which each of the symbol display areas 31 to 45 is associated with a predetermined random number range (see FIG. 11), to thereby determine a stopping area based on which symbol display area is associated with the random number range to which the random number thus sampled belongs. In the stopping area determination processing S14, the number of times a processing is executed corresponds to the number of characters determined in the character number determination processing S13. Accordingly, a stopping area is determined for each of all butterfly character images 90 displayed in the symbol display section 7. For example, in a case where a character number has been determined to be “10” in the character number determination processing S13, ten processings are executed in the stopping area determination processing S14 so that “10” stopping areas are determined. The main CPU 61 determines stopping areas the number of which corresponds to the character number, associates the stopping areas to respective butterfly character images 90, and stores them to the RAM 63. Then, the main CPU 61 advances the processing to S15.

In S15, the main CPU 61 executes a character display processing. The character display processing S15 is a processing for moving butterfly character images 90, the number of which has been determined in the character number determination processing S13, to the symbol display section 7 and then stopping the butterfly character images 90 in the stopping areas determined in the stopping area determination processing S14. In the character display processing S15, in addition, a movement pattern of each butterfly character image 90 moving in the symbol display section 7 is determined. Based on the movement pattern determined for each butterfly character image 90, the butterfly character image 90 moves in the symbol display section 7. The character display processing S15 is not described here because a detailed description thereof will be given later with reference to the drawings. When all the butterfly character images 90 displayed based on the character number are stopped in the respective stopping areas, the main CPU 61 advances the processing to S16.

Then, in S16, the main CPU 61 executes an award determination processing. In the award determination processing S16, whether a combination of symbols 46 placed in the stopping areas for respective butterfly character images 90, which have been determined in the stopping area determination processing S14, is a combination that causes any award or not is determined. More specifically, the main CPU 61 identifies a combination of symbols for the current game by referring to the stopping areas that have been determined in accordance with the character number. In this embodiment, as described above, symbols 46 placed in the respective symbol display areas 31 to 45 are always of the same kinds. Therefore, by referring to which symbol display area a stopping area is, a symbol 46 corresponding to the stopping area can be identified. By identifying symbols 46 corresponding to all the stopping areas, a combination of symbols in the current game can be identified. Then, the main CPU 61 determines whether the combination of symbols thus identified is a winning combination (see FIG. 5) or not, and determines an award (e.g., an amount of credits to be paid out) for the current game.

Then, in S17, based on a result of the award determination processing S16, the main CPU 61 determines whether a winning combination is made or not. When it is determined that a winning combination is made (S17: YES), the main CPU 61 advances the processing to S18. When it is determined that a winning combination is not made (S17: NO), the main CPU 61 ends the main game processing S2. Here, in a case where a next game is started continuously, the processings subsequent to S1 are executed again.

Then, in S18, the main CPU 61 executes a payout processing in which the main CPU 61 gives a player an award based on a result of determination made in the award determination processing. At this time, by pressing the CASHOUT button 20, a payout may be made in the form of coins equivalent to a credit value (one credit is equivalent to one coin) or in the form of a barcoded ticket. As the payout processing S18 ends, the main game processing S2 ends. Here, in a case where a next game is started continuously, the processings subsequent to S1 are executed again.

Next, a character display processing S15 in the main game processing will be described in detail with reference to the drawings. FIG. 12 is a flowchart showing a character display processing program. In the character display processing S15 after the character number determination processing S13 and the stopping area determination processing S14, the main CPU 61 executes a character display processing program.

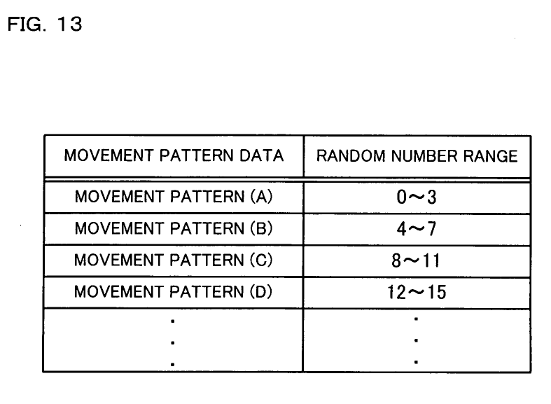

As the character display processing S15 starts, the main CPU 61 firstly executes a movement pattern determination processing S21. The movement pattern determination processing S21 is a processing for determining a movement pattern for each butterfly character image 90 displayed in the symbol display section 7 that are moving within the symbol display section 7. To be more specific, the main CPU 61 executes the random number generating program to thereby sample a random number from a predetermined random number range. Then, the main CPU 61 refers to a movement pattern determination table in which each of movement patterns is associated with a predetermined random number range (see FIG. 13), to thereby determine a movement pattern based on which movement pattern is associated with the random number range to which the random number thus sampled belongs. In the movement pattern determination processing S21, the number of times a processing is executed corresponds to the number of characters determined in the character number determination processing S13. Accordingly, a movement pattern is determined for each of all butterfly character images 90 displayed in the symbol display section 7. After storing the movement patterns for the respective butterfly character images 90 into the RAM 63, the main CPU 61 advances the processing to S22.

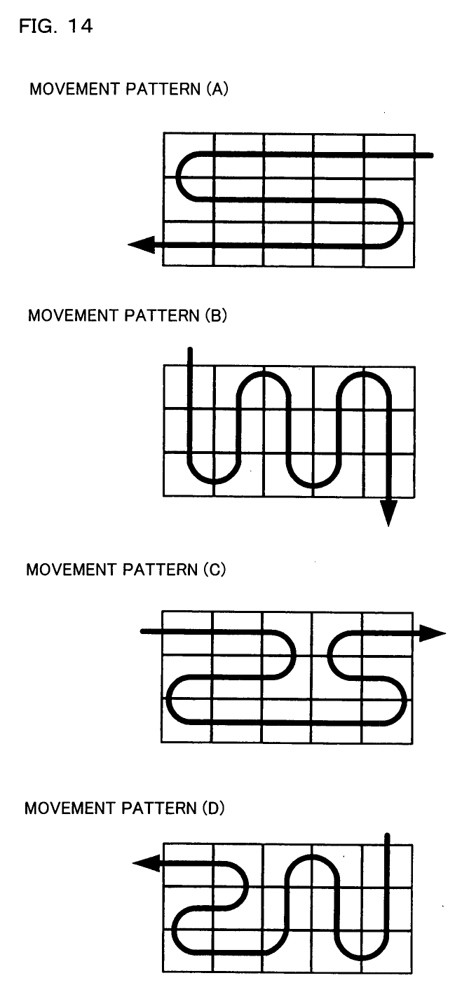

Here, a movement pattern for the butterfly character image 90 which is determined in the movement pattern determination processing S21 will be described in detail with reference to the accompanying drawings. FIG. 14 is an explanatory view showing examples of a movement pattern for a butterfly character image 90 in the symbol display section 7 according to this embodiment. As shown in FIG. 14, in movement patterns (A) to (D), a butterfly character image 90 moves within the symbol display section 7 in quite different manners. In the movement pattern (A), for example, a butterfly character image 90 starts moving leftward from the symbol display area 43, then goes horizontally across the symbol display areas located in upper, middle and lower parts of the symbol display section 7, and then reaches the symbol display area 33. In the movement pattern (B), a butterfly character image 90 starts moving downward from the symbol display area 31, then moves vertically through columns (five columns) of symbol display areas constituting the symbol display section 7, and then goes to the symbol display area 45. Like this, in the movement pattern determination processing S21, a movement pattern is determined from several different movement patterns. Therefore, a manner of movement of a butterfly character image 90 can be diversified.

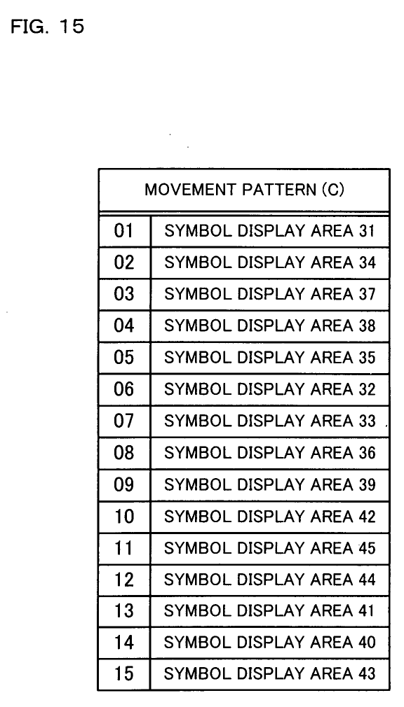

In each movement pattern, a butterfly character image 90 passes through all the symbol display areas 31 to 45 of the symbol display section 7, at least once. The movement pattern (C) will be described for example. FIG. 14 is an explanatory view schematically showing the movement pattern (C), and more specifically showing an order in which a butterfly character image 90 passes through the symbol display areas. In the movement pattern (C), as shown in FIGS. 14 and 15, a butterfly character image 90 moves within the symbol display section 7, in an order of the “symbol display area 31”, the “symbol display area 34”, and the “symbol display area 37”. The butterfly character image 90 passes through all the symbol display areas 31 to 45 included in the symbol display section 7, and reaches the “symbol display area 43”. Accordingly, when a movement pattern for a butterfly character image 90 is determined to be the movement pattern (C), the butterfly character image 90 moves within the symbol display section 7 in an order of the “symbol display area 31”, the “symbol display area 34”, and the “symbol display area 37”, and passes through all the symbol display areas 31 to 45 included in the symbol display section 7, to reach the “symbol display area 43” (see FIGS. 14 and 15).

When the butterfly character image 90 reaches a symbol display area that has been determined as a stopping area for this butterfly character image 90 in the stopping area determination processing S14, the butterfly character image 90 ends its movement based on the movement pattern and stops in the symbol display area as the stopping area. For example, in a case where a stopping area for a certain butterfly character image 90 moving in the movement pattern (C) has been determined to be the “symbol display area 35”, in the character display processing S15 the butterfly character image 90 moves in an order of the “symbol display area 31”, the “symbol display area 34”, the “symbol display area 37”, and the “symbol display area 38”, and then stops in the “symbol display area 35” when it reaches the symbol display area 35. In such a case, a movement of the butterfly character image 90 through the “symbol display area 32” to the “symbol display area 43” in the movement pattern (C) is not performed (see FIGS. 14 and 15).

After determining a movement pattern for every butterfly character image 90 displayed in the symbol display section 7 (S21), the main CPU 61 starts moving each butterfly character image 90 based on a movement pattern determined for each butterfly character image 90 (S22). At this time, stored on the second plane of the frame memory of the graphic board 68 are image data in which butterfly character images 90 corresponding to the character number determined in the character number determination processing S13 are arranged. In the VRAM, the image data stored in the second plane of the frame memory are composed with image data stored in the first plane in which prescribed symbols 46 are arranged in the respective symbol display areas 31 to 45. In composing the image data stored in the first and second planes of the frame memory, the image data stored in the second plane take priority. Thus, based on composition image data thus written in the VRAM, displaying on the lower display 6 is performed in execution of a game. Image data in the second plane of the frame memory are updated in sequence so as to make each butterfly character image 90 move in its movement pattern. Consequently, on the lower display 6 having composition image data displayed thereon, all butterfly character images 90 displayed in the symbol display section 7 move based on their respective movement patterns (S23).

After the butterfly character images 90 move within the symbol display section 7 based on their respective movement patterns, the main CPU 61 determines whether any butterfly character image 90 has reached a stopping area as a result of movement, or not (S24). When no butterfly character image 90 has reached a stopping area (S24: NO), the main CPU 61 returns the processing to S23. Thus, the butterfly character images 90 moving within the symbol display section 7 continue to move. When there is a butterfly character image 90 that has reached a stopping area (S24: YES), the main CPU 61 stops the butterfly character image 90 in this stopping area (S25). Then, the main CPU 61 adds “1” to a counter T that is formed in the RAM 63. A value of the counter T indicates the number of butterfly character images 90 stopped. After adding “1” to the counter T, the main CPU 61 advances the processing to S27.

In S27, the main CPU 61 determines whether all butterfly character images 90 within the symbol display section 7 are stopped or not. The main CPU 61 makes a determination in S27, based on a value of the counter T stored in the RAM 63 and the character number determined in the character number determination processing S13. When all butterfly character images 90 are stopped in the respective stopping areas (S27: YES), the main CPU 61 ends the character display processing S15 and shifts the processing to an award determination processing S16. When not all butterfly character images 90 within the symbol display section 7 are stopped in the respective stopping areas (S27: NO), the main CPU 61 returns the processing to S23. Thus, in the symbol display section 7, the butterfly character image 90 that has not yet been stopped in the stopping area continues to move.

Like this, in the gaming machine 1 of this embodiment, the butterfly character image 90 moves at random in the character display processing S15. Therefore, a manner of display in the symbol display section 7 can be diversified. To be more specific, when a movement pattern for a butterfly character image 90 differs (e.g., the movement pattern (B) and the movement pattern (D) shown in FIG. 14), the butterfly character image 90 moves to a stopping area in a largely different manner even though a stopping area for the butterfly character image 90 is the same symbol display area. In addition, when a stopping area for a butterfly character image 90 differs, the butterfly character image 90 moves to the stopping area in a different manner until stopped in the stopping area, even though a movement pattern for the butterfly character image 90 is the same. Moreover, several butterfly character images 90 which is based on a character number move in respective movement patterns. Therefore, a movement manner of the butterfly character image 90 in the symbol display section 7 can be diversified all the more.

### Second Embodiment

Next, a second embodiment of the present invention will be described in detail with reference to the accompanying drawings. In the second embodiment, the present invention is applied to a gaming machine 100 that adopts a mechanical reel. In the second embodiment, the same members and the same devices as those of the first embodiment will be denoted by the same reference numerals, and the same constructions as those of the first embodiment will not be described in detail.

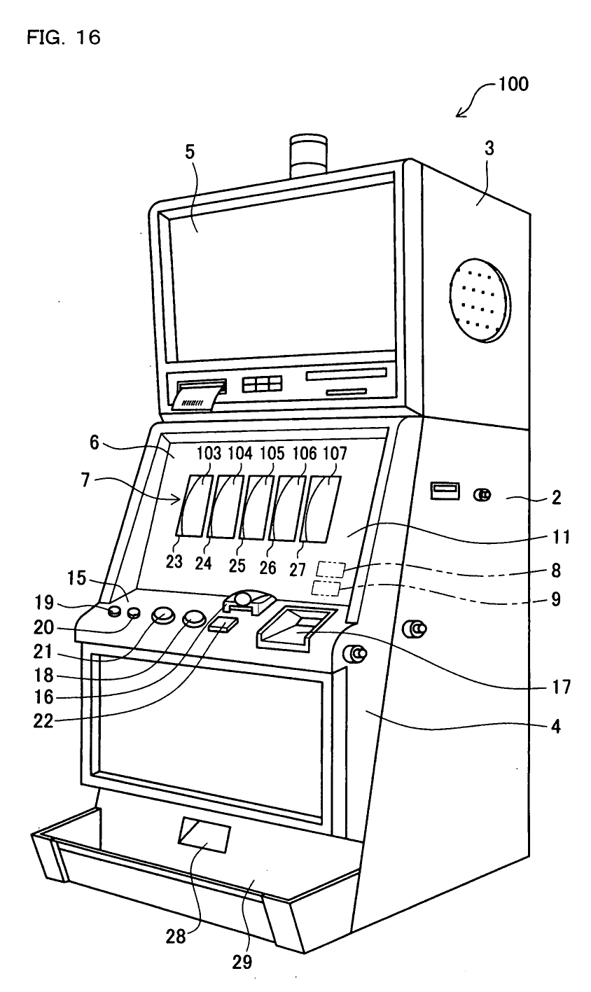

First, a general construction of the gaming machine 100 according to the second embodiment will be described with reference to the accompanying drawings. FIG. 16 is a perspective view showing an appearance of the gaming machine 100 according to the second embodiment. As shown in FIG. 16, a basic construction of the gaming machine 100 according to the second embodiment is the same as that of the gaming machine 1 according to the first embodiment. Here, unlike the so-called video gaming machine according to the first embodiment, the gaming machine 100 according to the second embodiment adopts a mechanical reel. Thus, the gaming machine 100 differs from the gaming machine 1 only in the mechanical reel. Accordingly, a detailed description will be given only to a construction of the mechanical reel. Here, the gaming machine 100 according the second embodiment includes a device and a mechanism adapted to control rotation and stopping of mechanical reels. However, in this second embodiment, the mechanical reels are not driven in rotation but fixed in predetermined positions, respectively.

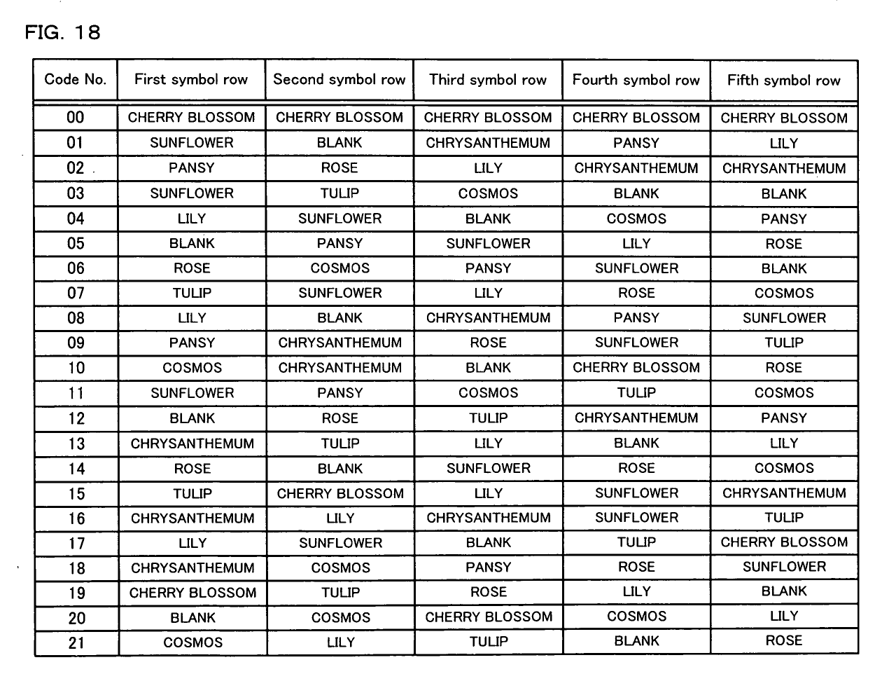

In the gaming machine 100, as shown in FIG. 16, a lower display 6 is provided on a front face of a main door 4. Here, the lower display 6 of the gaming machine 100 is formed of a transparent liquid crystal display. Reel display areas 23 to 27 are provided in a central portion of the lower display 6 so that an inside of a cabinet 2 of the gaming machine 100 can be seen. Inside the cabinet 2, mechanical reels 103 to 107 are rotatably disposed behind the reel display areas 23 to 27. Stepping motors 123 to 127 are provided for the mechanical reels 103 to 107, respectively. Columns of symbols (such as first to fifth columns of symbols) are shown on peripheral surfaces of the mechanical reels 103 to 107, respectively. The column of symbols includes nine kinds of symbols, namely, a “cherry blossom” symbol, a “chrysanthemum” symbol, a “cosmos” symbol, a “rose” symbol, a “sunflower” symbol, a “lily” symbol, a “tulip” symbol, a “pansy” symbol, and a “blank” symbol, arranged in different manners (see FIG. 18).

In the gaming machine 100, three symbols 46 are disposed in one reel display area. That is, each of the reel display areas 23 to 27 has three symbol display areas. As shown in FIG. 16, in the gaming machine 100 as well, a symbol display section 7 is made up of five reel display areas (reel display areas 23 to 27). Thus, the symbol display section 7 of the gaming machine 100 also includes symbol display areas 31 to 45. The symbol display areas 31 to 45 are arranged in the symbol display section 7, in a matrix with five columns and three rows. In the gaming machine 100, as described above, the mechanical reels 103 to 107 are fixed in the predetermined positions, respectively. Therefore, like in the first embodiment, kinds of symbols 46 placed in the respective symbol display areas 31 to 45 are also fixed.

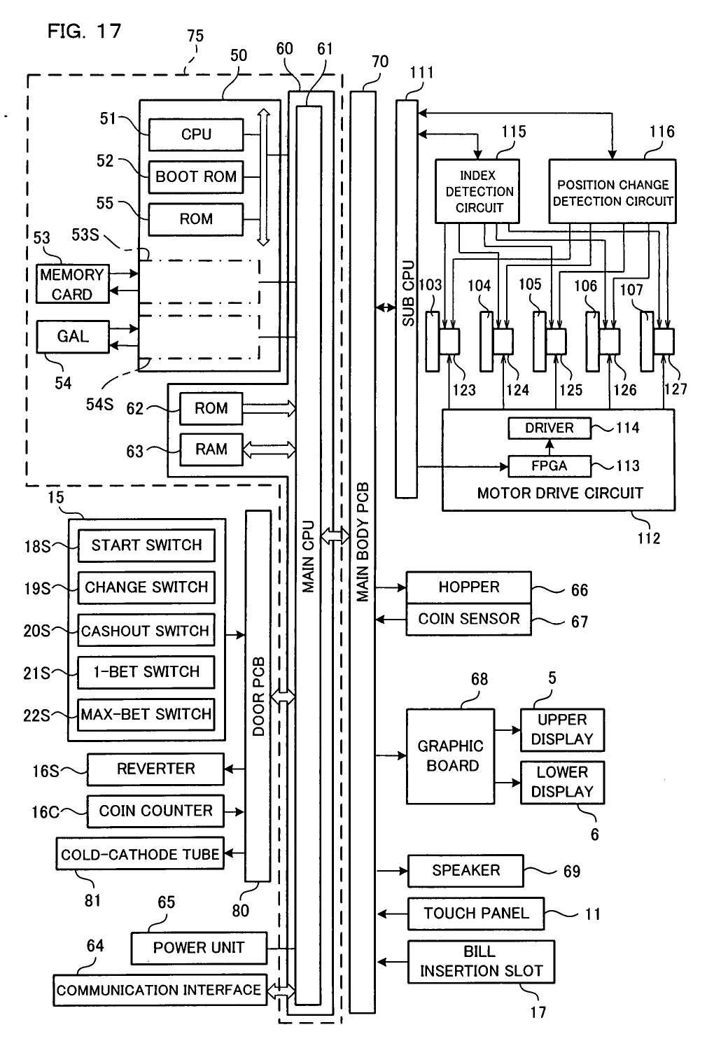

Next, a control system of the gaming machine 100 according to the second embodiment will be described in detail with reference to the drawings. FIG. 17 is a block diagram showing a control system of the gaming machine 100 according to the second embodiment. As described above, the gaming machine 100 according to the second embodiment differs from the gaming machine 1 according to the first embodiment only in mechanical reels 103 to 107. Therefore, a construction regarding the mechanical reels 103 to 107 will be described in detail. The other constructions are the same as the above-described ones of the gaming machine 1 according to the first embodiment, and repeated description thereof will be omitted here.

As shown in FIG. 17, a sub CPU 111 as well as a hopper 66, a coin sensor 67, a graphic board 68, a speaker 69, a touch panel 11, and a bill insertion slot 17 is connected to a main body PCB 70. The sub CPU 111 controls rotation and stopping of the mechanical reels 103 to 107. A motor drive circuit 112 including an FPGA (Field Programmable Gate Array) 113 and a driver 114 is connected to the sub CPU 111. The FPGA 113 is an electronic circuit such as a programmable LSI, and functions as a control circuit for the stepping motors 123 to 127. The driver 114 functions as an amplifier circuit for a pulse which will be inputted to the stepping motors 123 to 127. The stepping motors 123 to 127, which are of 1-2 phase excitation type, are connected to the motor drive circuit 112. The stepping motors 123 to 127 rotate the respective mechanical reels 103 to 107.

In addition, an index detection circuit 115 and a position change detection circuit 116 are connected to the sub CPU 111. The index detection circuit 115 detects a position, e.g. a reference point, of the rotating mechanical reels 103 to 107. The index detection circuit 115 also detects out-of-step of the mechanical reels 103 to 107. The position change detection circuit 116 detects a change of a stopping position of the mechanical reels 103 to 107 after rotation of the mechanical reels 103 to 107 is stopped. For example, in a case where a winning combination of symbols is actually not made but nevertheless a player forcibly changes a stopping position so as to make a winning combination of symbols, the position change detection circuit 116 detects a change of a stopping position of the mechanical reels 103 to 107.

In the gaming machine 100 having a construction shown in FIGS. 16 and 17, like in the first embodiment, a main control processing program (FIG. 8), a main game processing program (FIG. 9), and a character display processing (FIG. 12) are executed. Basic contents of these programs are the same as in the first embodiment, and therefore detailed descriptions of these programs will be omitted. In the first embodiment, image data stored in the first and second planes of the frame memory are composed, and image data thus composed are displayed on the lower display 6. In the second embodiment, however, only image data concerning butterfly characters 90 (which mean image data stored in the second plane) have to be displayed on the lower display 6. Therefore, composition of image data is not needed.

In the gaming machine 100 according to the second embodiment, as described above, symbols 46 placed in the symbol display areas 31 to 45 of the symbol display section 7 are fixed because the mechanical reels 103 to 107 are fixed. Therefore, it is not always necessary to provide the mechanical reels 103 to 107 and any attachment to the mechanical reels 103 to 107, and various modifications may be made. For example, it may be possible that, instead of the mechanical reels 103 to 107, a symbol display plate painted with a symbol display section 7 in which prescribed symbols 46 are already placed in the respective symbol display areas 31 to 45 is provided behind the lower display 6 which is a transparent liquid crystal panel. In this case, devices involved in the mechanical reel 103 to 107 (such as the stepping motors 123 to 127, the sub CPU 111, and the like) of the second embodiment may not be provided.

As described above, in the gaming machine 1 and the gaming machine 100 according to the present invention, the symbols 46 prescribed for the respective symbol display areas are placed in the fifteen symbol display areas 31 to 45 that are arranged in a 3-times-5 matrix. When a game starts, butterfly character images 90 the number of which corresponds to the character number determined in the character number determination processing S13 are displayed in the symbol display section 7 in the character display processing S15. Each butterfly character image 90 sequentially moves within the symbol display section 7 in accordance with each movement pattern determined in the movement pattern determination processing S21. Then, when, as a result of movement based on the movement pattern, each butterfly character image 90 reaches a symbol display area as a stopping area determined in the stopping area determination processing S14, the butterfly character image 90 stops in the symbol display area. When all the butterfly character images 90 displayed in the symbol display section 7 are stopped, an award given to a player is determined based on a combination of symbols placed in the symbol display areas in which the respective butterfly character images 90 are stopped (S16).

With this construction, at a start of a game, a player cannot know which ones of fifteen symbols 46 arranged in the symbol display section 7 will be included in an award-giving combination of symbols. This makes a player feel an increased sense of tension for an award given in the gaming machine.

As a stopping area for each butterfly character image 90, one symbol display area is randomly determined from the symbol display areas 31 to 45. Thereby, symbols 46 involved in an award determination for the current game is determined. Accordingly, it is difficult to guess in which symbol display areas symbols 46 decisive for an award will be displayed. Moreover, movement manners of the several butterfly character images 90 displayed within the symbol display section 7 are randomly determined from several movement patterns. Therefore, a movement pattern of the butterfly character images 90, which inform a player of symbols 46 decisive for an award, can be determined randomly with respect to both the stopping area and the movement pattern. Thus, it is difficult for a player to guess an award, and therefore the player can sufficiently enjoy expectation and tension for an award. In this point, the gaming machine of the present invention is largely different from the gaming machine based on an activated pay line which is so simple that an award can be guessed easily.

The present invention is not limited to the above-described embodiments. It is evident that various improvements and modification can be made without departing from the spirit and scope of the present invention. For example, although, in the first and second embodiments, symbols 46 placed in the respective symbol display areas 31 to 45 are fixed to be specific kinds of symbols preset. However, this is not limitative. In the present invention, it suffices that the character display processing S15 is performed under a state where placement of symbols 46 in the respective symbol display areas is completed. For example, in the second embodiment, it may be possible that, prior to the character number determination processing S12, the mechanical reels 103 to 107 are driven in rotation to rearrange symbols 46 in the respective symbol display areas 31 to 45 for every game. For example, further, in the first embodiment as well, it may be possible that the symbol display section 7 variably displays columns of symbols shown in FIG. 18 (first to fifth columns of symbols) for the respective five columns each including three symbol display areas (such as the symbol display areas 31, 32, and 33) to rearrange symbols 46 in the respective symbol display areas based on the columns of symbols shown in FIG. 18. Here, in this case of the first embodiment, it may also be possible that one symbol is rearranged by lottery from several symbols on a symbol display area basis independently of columns of symbols.

In the above-described embodiment, the symbol display section 7 is made up of symbol display areas that are arranged in a 3-times-5 matrix. However, this is not limitative, and various modes are acceptable. For example, the symbol display section 7 may be made up of symbol display areas that are arranged in a honeycomb-like form or in a pyramid-like shape.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A gaming machine comprising:
a display that displays thereon a symbol display area in which one of a plurality of kinds of symbols is arranged, and a symbol display frame made up of a plurality of symbol display areas; and
a game controller,
wherein the game controller performs:
moving a character that moves within the symbol display frame, in a state where symbols are displayed in the respective symbol display areas included in the symbol display frame;
determining one symbol display area in which the character will be stopped, from the plurality of symbol display areas included in the symbol display frame; and
determining an award given to a player based on a combination of symbols corresponding to symbol display areas in each of which the character is stopped.

2. The gaming machine according to claim 1, wherein, when displaying the character within the symbol display frame, the game controller performs:
determining the number of characters to be displayed in the symbol display frame; and
moving each character and then stopping each character in one symbol display area determined for each character.

3. The gaming machine according to claim 1, wherein always the same kinds of symbols preset for the respective symbol display areas are displayed in the respective symbol display areas included in the symbol display frame.

4. The gaming machine according to claim 2, wherein always the same kinds of symbols preset for the respective symbol display areas are displayed in the respective symbol display areas included in the symbol display frame.

5. The gaming machine according to claim 1, wherein the display displays thereon a symbol display frame made up of a plurality of symbol display areas that are arranged in a matrix.

6. A gaming machine comprising:
a display that displays thereon a symbol display area in which one of a plurality of kinds of symbols is arranged, and a symbol display frame made up of a plurality of symbol display areas; and
a game controller,
wherein the game controller performs:
determining a movement pattern of a character that moves within the symbol display frame, to be one of a plurality of patterns;
moving the character based on the movement pattern thus determined, in a state where symbols are displayed in the respective symbol display areas included in the symbol display frame;
determining one symbol display area in which the character will be stopped, from the plurality of symbol display areas included in the symbol display frame; and
determining an award given to a player based on a combination of symbols corresponding to symbol display areas in each of which the character is stopped.

7. The gaming machine according to claim 6, wherein, when displaying the character within the symbol display frame, the game controller performs:
determining the number of characters to be displayed in the symbol display frame; and
moving each character and then stopping each character in one symbol display area determined for each character.

8. The gaming machine according to claim 6, wherein always the same kinds of symbols preset for the respective symbol display areas are displayed in the respective symbol display areas included in the symbol display frame.

9. The gaming machine according to claim 7, wherein always the same kinds of symbols preset for the respective symbol display areas are displayed in the respective symbol display areas included in the symbol display frame.

10. The gaming machine according to claim 6, wherein the display displays thereon a symbol display frame made up of a plurality of symbol display areas that are arranged in a matrix.

11. A playing method for a gaming machine, wherein, when a game controller arranges symbols in a symbol display frame that is displayed on a display and made up of a plurality of symbol display areas in each of which one of a plurality of symbols is arranged, the game controller performs:
moving a character that moves within the symbol display frame, in a state where symbols are displayed in the respective symbol display areas included in the symbol display frame;
determining one symbol display area in which the character will be stopped, from the plurality of symbol display areas included in the symbol display frame; and
determining an award given to a player based on a combination of symbols corresponding to symbol display areas in each of which the character is stopped.

12. The playing method according to claim 11, wherein, when displaying the character within the symbol display frame, the game controller performs:
determining the number of characters to be displayed within the symbol display frame; and
moving each character and then stopping each character in one symbol display area determined for each character.

13. The playing method according to claim 11, wherein the game controller performs displaying, in the respective symbol display areas included in the symbol display frame, always the same kinds of symbols preset for the respective symbol display areas.

14. The playing method according to claim 12, wherein the game controller performs displaying, in the respective symbol display areas included in the symbol display frame, always the same kinds of symbols preset for the respective symbol display areas.

15. The playing method according to claim 11, wherein the game controller performs displaying the character within a symbol display frame made up of a plurality of symbol display areas that are arranged in a matrix.

16. A playing method for a gaming machine, wherein, when a game controller arranges symbols in a symbol display frame that is displayed on a display and made up of a plurality of symbol display areas in each of which one of a plurality of symbols is arranged, the game controller performs:
determining a movement pattern of a character that moves within the symbol display frame, to be one of a plurality of patterns;
moving the character based on the movement pattern thus determined, in a state where symbols are displayed in the respective symbol display areas included in the symbol display frame;
determining one symbol display area in which the character will be stopped, from the plurality of symbol display areas included in the symbol display frame; and
determining an award given to a player based on a combination of symbols corresponding to symbol display areas in each of which the character is stopped.

17. The playing method according to claim 16, wherein, when displaying the character within the symbol display frame, the game controller performs:
determining the number of characters to be displayed within the symbol display frame; and
moving each character and then stopping each character in one symbol display area determined for each character.

18. The playing method according to claim 16, wherein the game controller performs displaying, in the respective symbol display areas included in the symbol display frame, always the same kinds of symbols preset for the respective symbol display areas.

19. The playing method according to claim 17, wherein the game controller performs displaying, in the respective symbol display areas included in the symbol display frame, always the same kinds of symbols preset for the respective symbol display areas.

20. The playing method according to claim 16, wherein the game controller performs displaying the character within a symbol display frame made up of a plurality of symbol display areas that are arranged in a matrix.
